(19) United States
(12) Patent Application Publication
(10) Pub. No.: US 2016/0131888 A1
(43) Pub. Date: May 12, 2016

(54) TESTING SLIDE FOR MICROSCOPES EQUIPPED WITH WATER IMMERSION OR PHYSIOLOGY OBJECTIVES

(71) Applicant: Thorlabs, Inc., Newton, NJ (US)

(72) Inventors: Henry Haeberle, Reston, VA (US); Jeffrey S. Brooker, Oak Hill, VA (US)

(21) Appl. No.: 14/937,420

(22) Filed: Nov. 10, 2015

Related U.S. Application Data
(60) Provisional application No. 62/078,144, filed on Nov. 11, 2014.

(51) Int. Cl. G02B 21/34; G02B 21/33; G02B 21/16

(52) U.S. Cl. CPC G02B 21/34; G02B 21/16; G02B 21/33

(57) ABSTRACT

A testing slide for microscopes equipped with water immersion objectives. The slide has a chamber containing a solid with an index of refraction similar to that of water. Impregnated in this solid are fluorescent beads, scattered evenly throughout the material.

### CROSS-REFERENCE TO RELATED APPLICATIONS

This application claims the benefit of U.S. Provisional Application No. 62/078,144 filed on Nov. 11, 2014, the contents of which are herein incorporated by reference.

### FIELD OF THE INVENTION

The invention generally relates to testing slides. More particularly, the invention relates to a testing slide for microscopes equipped with water immersion or physiology objectives.

### BACKGROUND

In light microscopy, a water immersion or physiology objective is a specially designed objective lens used to image samples in water-like medium with maximum resolution. This is achieved by immersing the objective lens in the water-like medium along with the sample; since most live specimens live in water, a physiology objective can image live samples in their native state. Since the objective is designed to match the index of refraction of water, spherical aberrations are minimized and resolution maximized.

A sample slide is used to assess the imaging capabilities of microscopes equipped with objectives designed for water or media with a similar refractive index. The resolution and imaging capability of such microscopes are assessed by imaging fluorescent beads that are the same size as or smaller than the diffraction limited resolution limit, typically 200 nm for a multi-photon microscope, and 50-100 nm for a confocal microscope. Water-based dipping (physiology) objectives must be immersed in water or an alternative medium with a similar index of refraction to maximize their resolution. Unfortunately, testing the resolving capability of microscopes with such objectives is difficult because beads on the order of 50-200 nm move freely in water due to Brownian motion. Therefore, some method is needed to hold the beads in place during imaging while retaining the same index of refraction as water. Simply attaching the fluorescent beads to a glass slide and immersing in water does not work, as the optics at the water/glass boundary interfere with the resolution measurements.

The current dominant method for optical testing of water objectives is imaging fluorescent beads suspended in agar, agarose or polyacrylamine. All of these methods are problematic. There are two difficulties with agar and agarose. First, both agar and agarose is fragile. Agar and agarose are heat sensitive, and break down under high intensity light emitted from a laser source. Agar and agarose age and are degraded by microbes over time. Agar and agarose also are highly dependent on exact production methods, with small changes in manufacture introducing optical aberrations. In addition, agar/water mixtures have an index of refraction significantly higher than that of water. The other alternative, Hydrogels made of polyacrylamide, is also undesirable, because it is toxic, and is flexible, shifting under stress. Therefore, there is a need to have a testing slide that uses a material that is tougher, easier to produce, and more reproducible than the existing methods.

### SUMMARY

One embodiment of the invention provides a slide including: a chamber; and a mixture of fluorescent beads, solvent and adhesive in the chamber.

Another embodiment of the invention provides a method of manufacturing a slide, the method including: providing a chamber in the slide; mixing fluorescent beads in a solvent; introducing the fluorescent beads-solvent mixture into an adhesive; putting beads-solvent-adhesive mixture into the chamber; and curing the adhesive.

### BRIEF DESCRIPTION OF THE DRAWINGS

FIG. 1 illustrates a testing slide according to an embodiment.

FIG. 2 illustrates steps to manufacture a testing slide according to an embodiment.

### DETAILED DESCRIPTION OF HIE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist atone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

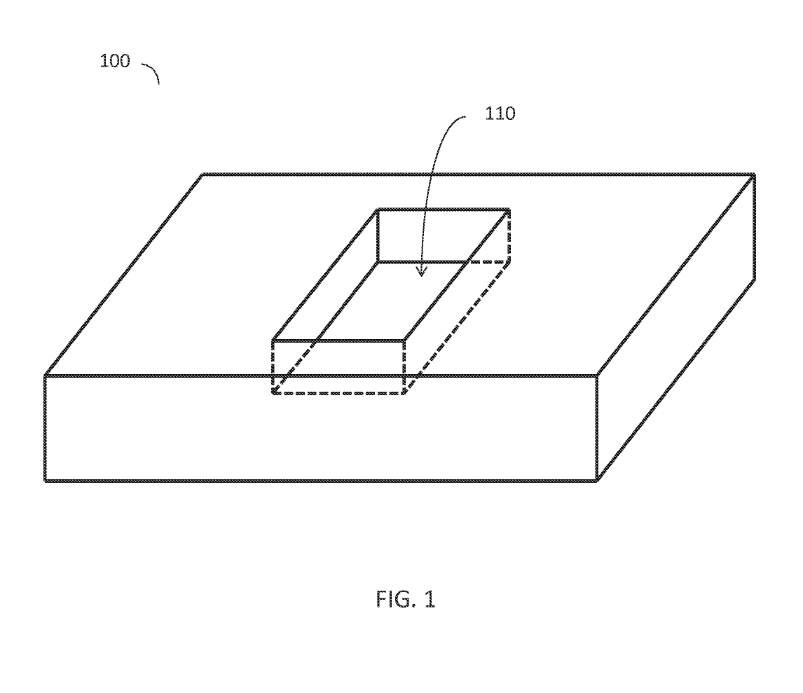

FIG. 1 shows a sample slide 100 that contains a chamber 110 containing a solid with an index of refraction similar to that of water, according to an embodiment. Impregnated in this solid are fluorescent beads, scattered evenly throughout the material.

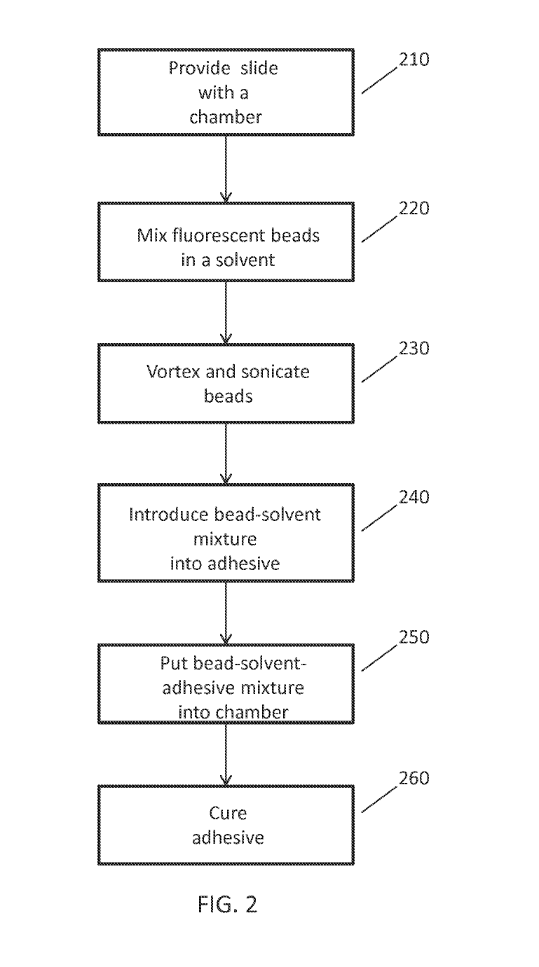

An embodiment of manufacturing a testing slide is shown in FIG. 2. In 210, a sample slide that contains a chamber is provided. In 220, fluorescent nanoparticles are placed dried, and re-suspended in acetone, or similar solvents that are hydrophobic, such as WE-71000 (3M), or HFE-7300. These fluorescent nanoparticles contain non-polar surface groups, such that they are resistant to, and soluble in, non-polar or organic solvents. One such example of a useful nanoparticle would be a bead, filled with quantum dots, covered with non-polar surface groups. In 230, the beads are vortexed and sonicated to ensure all bead aggregates are dissociated. In 240, the Butyl acetate/bead mixture is introduced in an optical adhesive and encapsulant, such as MY-133 (Electro-Optical Components.). In one embodiment, this adhesive contains 90% polymers in a freon substitute solvent. In 250, the bead-solvent-adhesive mixture is then placed in a sample slide well. In 260, the adhesive is then cured by isolating from oxygen and exposed to a light of wavelength 340-380 nm.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A slide comprising:
a chamber; and
a mixture of fluorescent beads, solvent and adhesive in the chamber.

2. The slide of claim 1, wherein the mixture has a refractive index that is substantially the same as the refractive index of water.

3. The slide of claim 1, wherein the solvent is hydrophobic.

4. The slide of claim 1, wherein the solvent comprises acetone.

5. The slide of claim 1, wherein the adhesive comprises about 90% polymers in a freon substitute solvent.

6. The slide of claim 1, wherein the fluorescent beads contain non-polar surface groups.

7. A method of manufacturing a slide, the method comprising:
providing a chamber in the slide;
mixing fluorescent beads in a solvent;
introducing the fluorescent beads-solvent mixture into an adhesive;
putting beads-solvent-adhesive mixture into the chamber; and
curing the adhesive.

8. The method of claim 7, wherein the beads are vortexed and sonicated such that all bead aggregates are dissociated.

9. The method of claim 7, wherein the solvent is hydrophobic.

10. The method of claim 7, wherein the solvent comprises acetone.

11. The method of claim 7, wherein the adhesive comprises about 90% polymers in a freon substitute solvent.

12. The method of claim 7, wherein adhesive is cured by isolating from oxygen and exposed to light.

13. The method of claim 12, wherein the light has a wavelength of 340-380 nm.

14. The method of claim 7, wherein the fluorescent beads contain non-polar surface groups.
